(19) United States
(12) Patent Application Publication
(10) Pub. No.: US 2022/0194384 A1
(43) Pub. Date: Jun. 23, 2022

(54) INPUT APPARATUS FOR VEHICLE AND METHOD THEREOF

(71) Applicant: HYUNDAI MOBIS CO., LTD., Seoul (KR)

(72) Inventor: Myeong Je KIM, Yongin-si (KR)

(73) Assignee: HYUNDAI MOBIS CO., LTD., Seoul (KR)

(21) Appl. No.: 17/506,721

(22) Filed: Oct. 21, 2021

(30) Foreign Application Priority Data
Dec. 23, 2020 (KR) 10-2020-0182473

(51) Int. Cl. B60W 40/04; G06K 9/00; G06T 7/73; B60W 50/10

(52) U.S. Cl. CPC B60W 40/04; G06K 9/00805; G06T 7/73; G06F 3/0482; B60W 50/10; G06T 2207/30261; G06T 2200/24; G06K 9/00201

(57) ABSTRACT

An input apparatus for a vehicle according to the present disclosure includes an image output device that outputs an image block including a predetermined vehicle control command image, an image input device that photographs the image block to recognize a position of the image block, an object detection device that detects an object on the image block, and a controller that generates a matrix coordinate which is mapped to correspond a position detection depending on a sensing signal of the object detection device on a position of the image block recognized through the image input device, and then that executes a vehicle control command corresponding to a matrix coordinate of a position where the object is positioned when the object detection device detects the object on the image block.

### CROSS-REFERENCE TO RELATED APPLICATIONS

This application claims the benefit of priority to Korean Patent Application No. 10-2020-0182473, filed in the Korean Intellectual Property Office on Dec. 23, 2020, the entire contents of which are incorporated herein by reference.

### BACKGROUND OF THE INVENTION

### 1. Field of the Invention

The present disclosure relates to an input apparatus for a vehicle and a method thereof, and more particularly, relates to an input apparatus and an input method for a vehicle that allow a driver to remotely control the vehicle in a situation in which both hands cannot be freely used.

### 2. Discussion of Related Art

In modern society, a vehicle is one of the most common means of transportation, and the number of people using vehicles is increasing. For a convenience of a driver using a vehicle, various sensors and electronic devices are being provided.

In particular, for driving convenience of drivers, research on an advanced driver assistance system (ADAS) is being actively conducted and development of an autonomous vehicle is being actively conducted.

Accordingly, as autonomous vehicles are commercialized, various sensors such as radar, LiDAR, camera, and the like are installed in the vehicles.

However, even in a vehicle equipped with various sensors for the driver's driving convenience, when there is a heavy load on the driver's hands or when there is a vehicle in a narrow parking space, it is still inconvenient for the driver to get into the vehicle or load a luggage in a trunk of the vehicle.

### BRIEF SUMMARY OF THE INVENTION

The present disclosure has been made to solve the above-mentioned problems occurring in the prior art while advantages achieved by the prior art are maintained intact.

An aspect of the present disclosure provides an input apparatus and an input method for a vehicle capable of providing a convenience, which allow a driver to remotely control the vehicle in a situation in which both hands cannot be freely used.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an input apparatus for a vehicle includes an image output device that outputs an image block including a predetermined vehicle control command image, an image input device that photographs the image block to recognize a position of the image block, an object detection device that detects an object on the image block, and a controller that generates a matrix coordinate which is mapped to correspond a position detection depending on a sensing signal of the object detection device on a position of the image block recognized through the image input device, and then that executes a vehicle control command corresponding to a matrix coordinate of a position where the object is positioned when the object detection device detects the object on the image block.

In an embodiment, the image input device may be a camera having a function of detecting the position of the image block and the object on the image block.

In an embodiment, the object detection device may be a LiDAR or a radar.

In an embodiment, the controller may generate the matrix coordinate by repeatedly performing a process of detecting the object through the object detection device at each position of the image block recognized through the image input device.

In an embodiment, the controller may allow the image block to be output in a reduced horizontal and vertical ratio.

In an embodiment, the controller may allow an output direction of the image block to be changed to upper or lower.

In an embodiment, the controller may allow the image block to be selected based on a position selection of a user in a remote space of a predetermined area formed around the vehicle.

According to an aspect of the present disclosure, an input apparatus for a vehicle includes an image output device that outputs an image block including a predetermined vehicle control command image, an image input device that photographs the image block to recognize a position of the image block, and recognizes depth information of detecting an object on the image block, and a controller that generates a matrix coordinate which is mapped to correspond a position detection depending on the depth information on a position of the image block recognized through the image input device, and then that executes a vehicle control command corresponding to a matrix coordinate of a position where the object is positioned when the image input device detects the object on the image block.

According to an aspect of the present disclosure, an input method for a vehicle includes outputting an image block including a predetermined vehicle control command image, recognizing a position of the image block by photographing the image block, generating a matrix coordinate which is mapped to correspond a position detection depending on a sensing signal of detecting an object on the image block on a position of the recognized image block, and executing a vehicle control command corresponding to a matrix coordinate of a position where the object is positioned when the object on the image block is detected.

In an embodiment, the outputting of the image block including the predetermined vehicle control command image may include outputting the image block by reducing a horizontal and vertical ratio of the image block.

In an embodiment, the outputting of the image block including the predetermined vehicle control command image may include outputting the image block by changing an output direction of the image block to upper or lower.

In an embodiment, the recognizing of the position of the image block by photographing the image block, and the generating of the matrix coordinate which is mapped to correspond the position detection depending on the sensing signal of detecting the object on the image block on the position of the recognized image block may include performing a function of detecting the object on the image block while recognizing the position of the image block through a camera capable of recognizing depth information.

In an embodiment, the generating of the matrix coordinate which is mapped to correspond the position detection depending on the sensing signal of detecting the object on the image block on the position of the recognized image block may include generating the matrix coordinate by repeatedly performing a process of detecting the object at each position of the recognized image block.

In an embodiment, the generating of the matrix coordinate which is mapped to correspond the position detection depending on the sensing signal of detecting the object on the image block on the position of the recognized image block may include detecting the object on the image block through a LiDAR or a radar.

In an embodiment, the executing of the vehicle control command corresponding to the matrix coordinate of the position where the object is positioned when the object on the image block is detected may include selecting the image block, based on a position selection of a user in a remote space of a predetermined area formed around the vehicle.

### BRIEF DESCRIPTION OF THE DRAWINGS

The above and other objects, features and advantages of the present disclosure will be more apparent from the following detailed description taken in conjunction with the accompanying drawings:

FIG. 1 is a diagram illustrating a vehicle equipped with an input apparatus for a vehicle according to an embodiment of the present disclosure;

FIG. 2 is a block diagram illustrating an input apparatus for a vehicle according to an embodiment of the present disclosure;

FIGS. 3 to 5 are diagrams describing a setting process of an input apparatus for a vehicle according to an embodiment of the present disclosure;

FIG. 6 is a diagram describing an example of use through an input apparatus for a vehicle according to an embodiment of the present disclosure;

FIGS. 7 to 11 are diagrams describing operation aspects of an input apparatus for a vehicle according to an embodiment of the present disclosure;

FIG. 12 is a diagram describing a process of determining whether to use an input apparatus for a vehicle according to an embodiment of the present disclosure;

FIGS. 13 and 14 are diagrams describing an operation of an input apparatus for a vehicle while driving according to an embodiment of the present disclosure; and

FIG. 15 is a flowchart illustrating an input method for a vehicle according to an embodiment of the present disclosure.

### DETAILED DESCRIPTION OF THE INVENTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

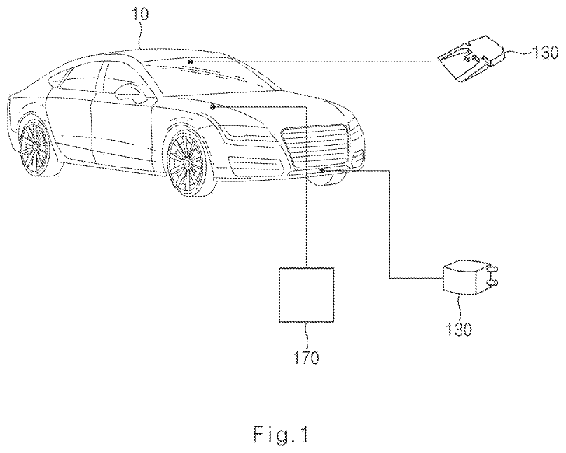

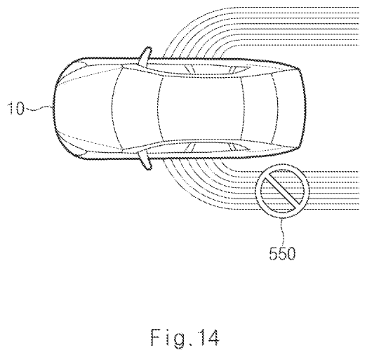

Hereinafter, embodiments of the present disclosure will be described in detail with reference to FIGS. 1 and 14.

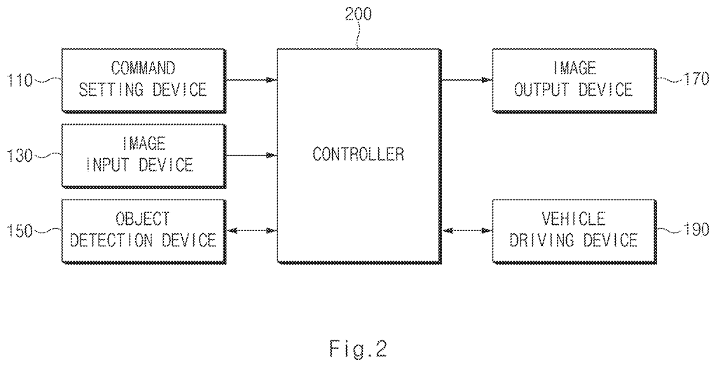

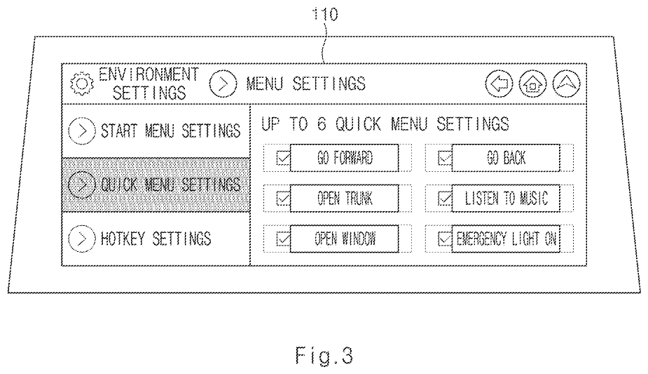

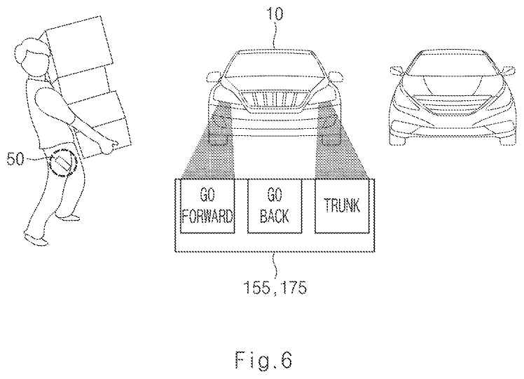

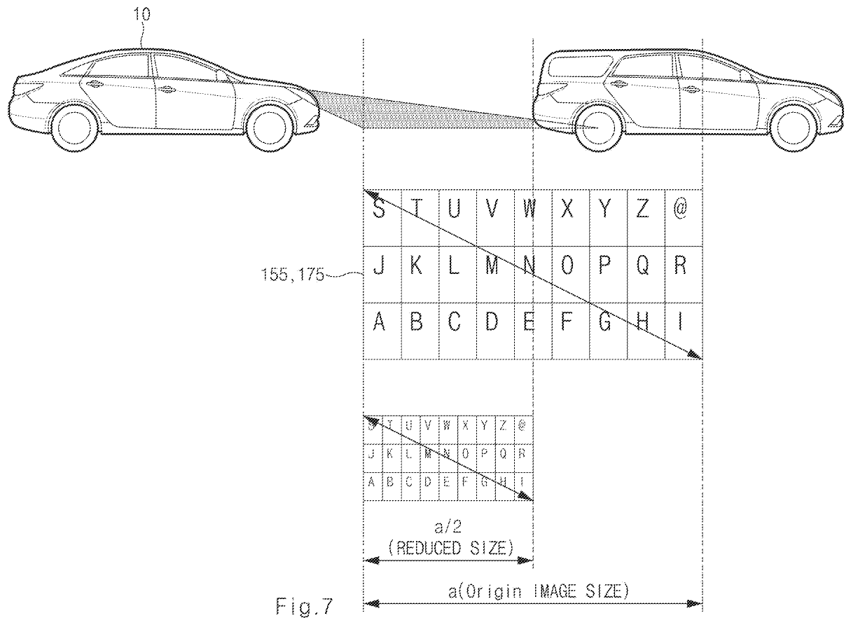

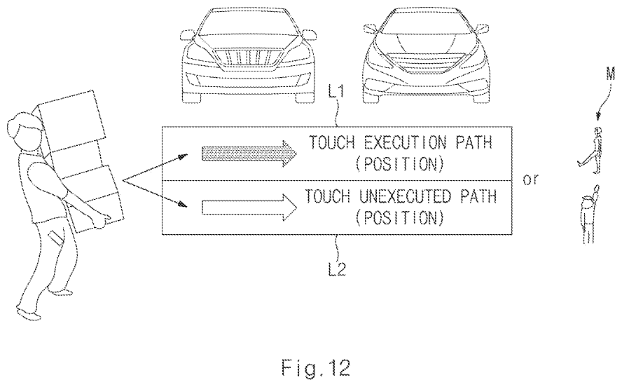

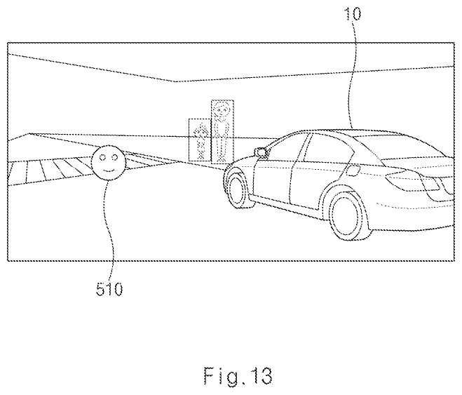

FIG. 1 is a diagram illustrating a vehicle equipped with an input apparatus for a vehicle according to an embodiment of the present disclosure, FIG. 2 is a block diagram illustrating an input apparatus for a vehicle according to an embodiment of the present disclosure, FIGS. 3 to 5 are diagrams describing a setting process of an input apparatus for a vehicle according to an embodiment of the present disclosure, FIG. 6 is a diagram describing an example of use through an input apparatus for a vehicle according to an embodiment of the present disclosure, FIGS. 7 to 11 are diagrams describing operation aspects of an input apparatus for a vehicle according to an embodiment of the present disclosure, FIG. 12 is a diagram describing a process of determining whether to use an input apparatus for a vehicle according to an embodiment of the present disclosure, and FIGS. 13 and 14 are diagrams describing an operation of an input apparatus for a vehicle while driving according to an embodiment of the present disclosure.

Referring to FIGS. 1 and 2, an input apparatus for a vehicle according to an embodiment of the present disclosure may include a command setting device 110, an image input device 130, an object detection device 150, an image output device 170, a vehicle driving device 190, and a controller 200.

Referring to FIG. 3, the command setting device 110 may be provided inside a vehicle 10, and while a driver looks at the display screen in a form of a touch screen, a desired vehicle control command (e.g., go forward, go back, open the trunk, or the like) among various vehicle control commands may be registered by selecting of the driver.

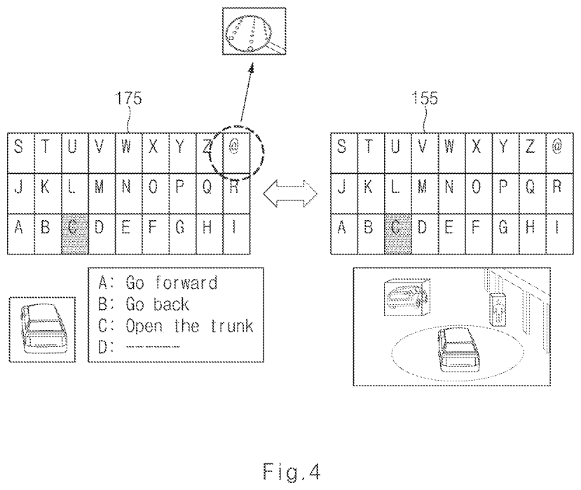

Referring to FIG. 4, the image output device 170 may be composed of a high-resolution matrix LED, a micro LED, a DMD, or the like, to output an image block 175 in the form of a matrix to a road surface around the vehicle 10.

In addition, the vehicle control command registered through the command setting device 110 in each square area constituting the image block 175 displayed on the road surface may be displayed as a vehicle control command image such as letters or symbols.

For example, referring to FIG. 4, the letters or the symbols corresponding to the “go forward” may be displayed in an area “A” constituting the image block 175, and the letters or the symbols corresponding to the “go back” may be displayed in an area “B”, and the letters or symbols corresponding to the “open the trunk” may be displayed in an area “C”.

The image input device 130 may be implemented with a camera, and may photograph or capture the image block 175 output to the road surface through the image output device 170 to determine or recognize a position of the image block 175.

The object detection device 150 may include a radar, a LiDAR, or the like, and may detect an object on the image block 175.

The controller 200 may generate a matrix coordinate 155 mapped such that a position detection depending on a sensing signal of the object detection device 150 corresponds to a position of the image block 175 recognized through the image input device 130.

In detail, since the object detection device 150 does not detect light, the matrix coordinate 155 may be generated by repeating a process of recognizing the position of each area on the image block 175 through the image input device 130 after positioning the object in each area on the image block 175 and then lighting the LED and a process of recognizing the object positioned in each area on the image block 175 through the object detection device 150.

That is, the image input device 130 may photograph or capture the image block 175 to form mapping data in units of pixels, and based on this, the matrix coordinate 155 may be generated by mapping the coordinate based on the position of the object detected by the object detection device 150 with the data mapped in units of pixels once again.

By doing this, when the object on the matrix coordinate 155 mapped to correspond to the image block 175 is recognized, a vehicle control command included in the area of the image block 175 may be selected.

On the other hand, when the image block 175 and the matrix coordinate 155 corresponding thereto are out of alignment with each other, coordinate calibration may be required.

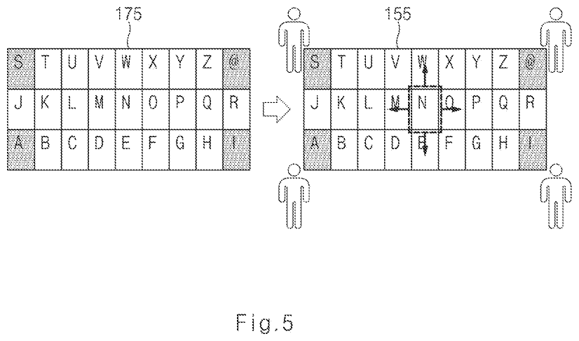

As a process of correcting the matrix coordinate 155 corresponding to the image block 175, referring to FIG. 5, the matrix coordinate 155 corresponding to the image block 175 may be corrected by sequentially lighting the LED to four corner areas of an outer edge of the image block 175 while photographing or capturing the image block 175 through the image input device 130 and by detecting the object existing in the four corner areas through the object detection device 150.

In this way, when the position information of the four corner areas of the image block 175 is known, position information associated with a center may be estimated.

When the object detection device 150 detects the object on the image block 175, the controller 200 may drive the vehicle driving device 190 of the vehicle such that the vehicle control command corresponding to the matrix coordinate 155 of the position where the object is positioned is executed.

Therefore, when the driver selects the vehicle control command image to control the vehicle from the image block 175 output on the road surface, the corresponding position is recognized through the object detection device 150, and the vehicle driving device 190 may be driven to execute the vehicle control command of the corresponding position.

For example, referring to FIG. 6, when the driver moves to a position where the image of the forward is formed in a situation in which the driver cannot use both hands to carry a load, after recognizing that it is a position corresponding to the forward through the object detection device 150, when the driver stands in a stationary state for a predetermined time, the vehicle driving device 190 may be driven such that the vehicle 10 moves forward.

When the driver moves to a position where the image of the backward is formed, after recognizing that it is a position corresponding to the backward through the object detection device 150, when the driver stands in a stationary state for a predetermined time, the vehicle driving device 190 may be driven such that the vehicle 10 moves backward.

As in the above description, when the driver moves to a position where the image for trunk opening is formed, after recognizing that it is a position corresponding to the trunk opening through the object detection device 150, when the driver stands in a stationary state for a predetermined time, the vehicle driving device 190 may be driven to open the trunk of the vehicle 10.

Referring to FIG. 7, when the image block 175 is displayed to a road surface in front of the vehicle 10 and overlaps with another vehicle in front, the driver may not be able to select a desired vehicle control command.

In this case, when it is determined that there is an obstacle in an area where the image block 175 should be displayed through the object detection device 150, the controller 200 may measure a distance to the obstacle and calculate a distance that may be displayed while the image block 175 does not overlap another vehicle, and then may allow a horizontal or vertical magnification of the image block 175 to be reduced and displayed on the road surface by the reduced distance.

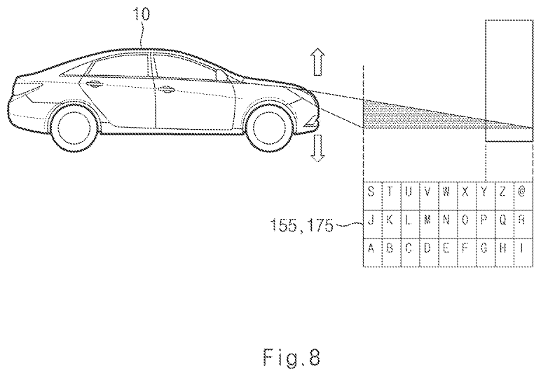

Referring to FIG. 8, by configuring the image output device 170 to rotate upward or downward, an output angle of the image block 175 may be moved upward or downward.

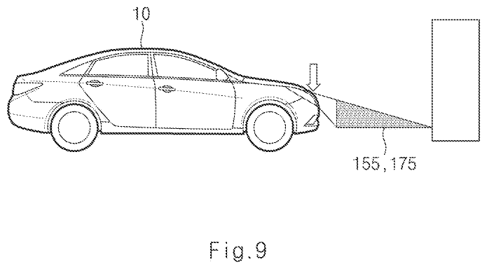

Therefore, when the image block 175 is displayed to the road surface of in front of the vehicle 10, and the driver cannot select the desired vehicle control command due to overlapping another vehicle in front, as illustrated in FIG. 9, by lowering the output angle of the image block 175 by rotating the image output device 170 downward, the image block 175 may be displayed on the road surface without overlapping with another vehicle in front.

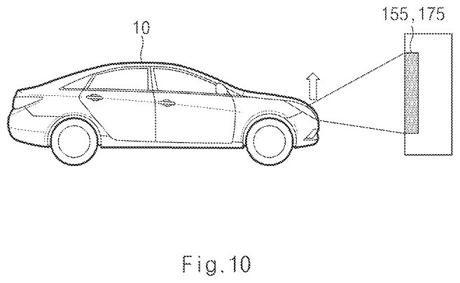

Referring to FIG. 10, when the image block 175 is displayed to the road surface of in front of the vehicle 10, and the driver cannot select the desired vehicle control command due to overlapping a wall rather than another vehicle in front, by increasing the output angle of the image block 175 by rotating the image output device 170 upward, the image block 175 may be displayed on the wall.

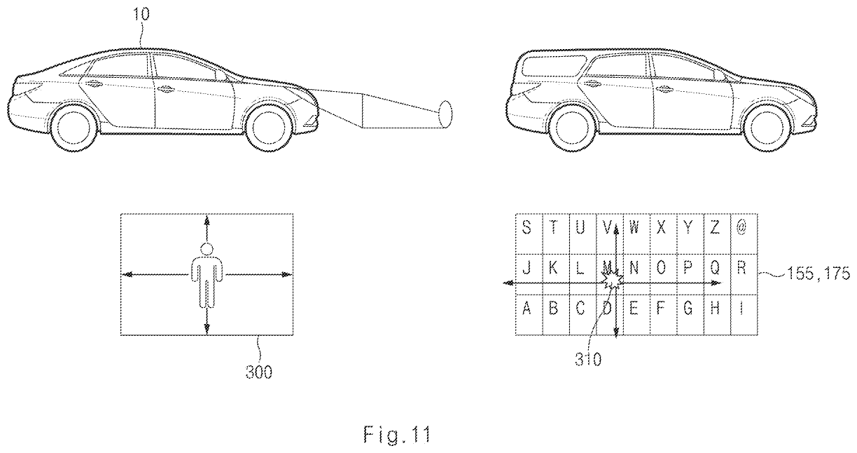

Referring to FIG. 11, in a state in which the image block 175 is displayed to the road surface in front of the vehicle 10, when a free space between the vehicle 10 and another vehicle in front is narrow as another vehicle is positioned close to the front, even if the magnification of the image block 175 is reduced or the output angle of the image block 175 is moved upward or downward, the driver may not be able to select a desired vehicle control command.

In this case, the controller 200 may form a remote space 300 of a predetermined area around the vehicle 10 within the detection range of the object detection device 150, and may display a selection tab 310 in the form of a cursor on the image block 175 to be output.

Subsequently, based on a movement of the driver's position in the remote space 300, the selection tab 310 may be moved to select the vehicle control command image included in the image block 175 through the selection tab 310.

Meanwhile, it is possible to select whether to use the image block 175 depending on a situation.

Referring to FIG. 12, when a specific path L1 within the detection range of the object detection device 150 is set adjacent to the vehicle 10, and when the driver intends to use the image block 175, the image block 175 may be output when the driver passes specific path L1.

Alternatively, when the driver intends to use the image block 175 after storing information on a specific motion ‘M’, the image block 175 may be output by taking the specific motion ‘M’ toward the image input device 130.

In addition, when the driver does not want to use the image block 175, the image block 175 may not be output when the driver passes a preset unexecuted path L2.

As may be used by applying the image output device 170 while the vehicle is driving, and as illustrated in FIG. 13, the vehicle 10 may stop adjacent to a crosswalk due to a stop signal while driving a road.

In this case, when a crosswalk and a pedestrian are recognized through the image input device 130 and the object detection device 150, by indicating that the vehicle 10 recognizes the pedestrian by outputting a smile image 510 onto the crosswalk through the image output device 170, the pedestrian may cross the crosswalk more safely.

Referring to FIG. 14, while the vehicle 10 is driving on a road, when another vehicle approaches close, a risk of a collision may occur.

In this case, when it is recognized that another vehicle is entered a specific position preset through the image input device 130 and the object detection device 150, by outputting an access prohibition image 550 to a specific position through the image output device 170 so that a driver of another vehicle recognizes the presence of the vehicle 10. Accordingly, it is possible to prevent a collision accident between the vehicle 10 and another vehicle.

On the other hand, when the image input device 130 is implemented as a camera capable of recognizing depth information, such as an infrared (IR) camera or a depth camera, the camera may replace the function of the object detection device 150.

Therefore, when the camera capable of recognizing the depth information is used, even if the object detection device 150 is not present, the image block 175 may be photographed or captured to recognize or determine the position of the image block 175, and the object on the image block 175 may be detected.

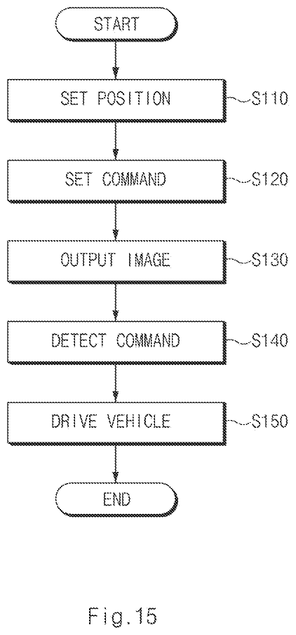

Hereinafter, an input method for a vehicle according to another embodiment of the present disclosure will be described in detail with reference to FIG. 15.

FIG. 15 is a flowchart illustrating an input method for a vehicle according to an embodiment of the present disclosure.

Hereinafter, it is assumed that the input apparatus for a vehicle of FIG. 2 performs the process of FIG. 15.

First, the image block 175 is output to the outside of the vehicle 10 through the image output device 170, and the position of the image block 175 may be recognized by photographing or capturing the image block 175 through the image input device 130 (S110).

Subsequently, a desired vehicle control command from among several selectable vehicle control commands through the command setting device 110 may be selected and registered (S120).

Subsequently, the vehicle control command registered through the command setting device 110 may be displayed with a vehicle control command image such as letters or symbols in the square area of the image block 175 displayed on the road surface (S130).

Subsequently, when the driver selects the vehicle control command image included in the image block 175, the corresponding position through the object detection device 150 may be recognized (S140), the vehicle driving device 190 may be driven to execute the vehicle control command of the corresponding position (S150).

As described above, according to the present disclosure, it is possible to provide convenience by allowing the driver to remotely control the vehicle in a situation in which both hands cannot be freely used.

In addition, as the autonomous driving market expands, market requirements for intelligent lamps are increasing, and interest in communication lamps is also increasing. When first-generation communication is a unidirectional road surface information display, second-generation communication may be expected to be a bidirectional communication.

Accordingly, the most basic function for interactive communication may be a touch recognition function, and the present disclosure has the effect of preoccupying such a technology.

According to the present disclosure, an embodiment of the present disclosure may provide convenience by allowing a driver to remotely control a vehicle in a situation in which both hands cannot be freely used.

In addition, various effects may be provided that are directly or indirectly understood through the present disclosure.

The above description is merely illustrative of the technical idea of the present disclosure, and those of ordinary skill in the art to which the present disclosure pertains will be able to make various modifications and variations without departing from the essential characteristics of the present disclosure.

Accordingly, the embodiments disclosed in the present disclosure are not intended to limit the technical idea of the present disclosure, but to explain the technical idea, and the scope of the technical idea of the present disclosure is not limited by these embodiments. The scope of protection of the present disclosure should be interpreted by the following claims, and all technical ideas within the scope equivalent thereto should be construed as being included in the scope of the present disclosure.

What is claimed is:

1. An input apparatus for a vehicle, comprising:
an image output device configured to output an image block including a vehicle control command image;
an image input device configured to capture the image block and determine a position of the image block;
an object detection device configured to detect an object on the image block; and
a controller configured to:
generate a matrix coordinate mapping a position of the detected object to the determined position of the image block; and
execute a vehicle control command corresponding to the matrix coordinate of the detected position of the object.

2. The input apparatus of claim 1, wherein the image input device comprises a camera and is configured to detect the position of the image block and the position of the object on the image block.

3. The input apparatus of claim 1, wherein the object detection device comprises a LiDAR or a radar function.

4. The input apparatus of claim 1, wherein the controller is configured to generate the matrix coordinate by repeatedly detecting the object using the object detection device at each position of the image block determined by the image input device.

5. The input apparatus of claim 1, wherein the controller is configured to output the image block in a reduced horizontal and vertical ratio.

6. The input apparatus of claim 1, wherein the controller is configured to change an output direction of the image block vertically.

7. The input apparatus of claim 1, wherein the controller is configured to select the image block on a driver's selection of a position in an area around the vehicle.

8. An input apparatus for a vehicle, comprising:
an image output device configured to output an image block including a vehicle control command image;
an image input device configured to capture the image block, determine a position of the image block, and extract depth information of an object on the image block; and
a controller configured to:
generate a matrix coordinate mapping a position of the detected object to the determined position of the image block; and
execute a vehicle control command corresponding to a matrix coordinate of the detected position of the object.

9. An input method for a vehicle comprising:
producing an image block including a vehicle control command image;
determining a position of the image block by capturing the image block;
detecting an object on the image block;
generating a matrix coordinate mapping a position of the detected object to the determined position of the image block; and
executing a vehicle control command corresponding to the matrix coordinate of the detected position of the object.

10. The input method of claim 9, wherein outputting the image block includes outputting the image block in a reduced horizontal and vertical ratio.

11. The input method of claim 9, wherein outputting the image block including the predetermined vehicle control command image includes changing an output direction of the image block vertically.

12. The input method of claim 9, wherein the object on the image block is determined while determining the position of the image block through a camera capable of extracting depth information of the detected object on the image block.

13. The input method of claim 9, wherein generating the matrix coordinate includes generating the matrix coordinate by repeatedly detecting the object at each position of the image block.

14. The input method of claim 9, wherein the object on the image block is detected by a LiDAR or a radar function.

15. The input method of claim 9, wherein executing the vehicle control command includes selecting the image block, based on a user's selection of a position in an area around the vehicle.
